(19) United States
(12) Patent Application Publication
(10) Pub. No.: US 2004/0054620 A1
(43) Pub. Date: Mar. 18, 2004

(54) Method and apparatus for calculating prepayment factor score

(76) Inventor: Michael Bykhovsky, San Francisco, CA (US)

Correspondence Address: RONALD CRAIG FISH, RONALD CRAIG FISH, A LAW CORPORATION, POST OFFICE BOX 2258, MORGAN HILL, CA, 95038, US

(21) Appl. No.: 10/247,457

(22) Filed: Sep. 18, 2002

(51) Int. Cl. G06F 17/60

(52) U.S. Cl. 705/38

(57) ABSTRACT

A method of calculating a prepayment score which summarizes the effects of one or more other factors which affect the prepayment propensity on a mortgage loan but which are normally ignored comprises: (1) analyzing a population of loans and selecting a class of loans which have similar characteristics of coupon rate, loan type, age and weighted average maturity and calculating a prepayment model using said characteristics which define the class as input arguments along with vectors of 30-year and 15-year projected mortgage rates or other interest rate projections reflective of mortgage interest rates, with the differences in the loans in said class being variations in one or more other factors which are to be summarized in one or more prepayment scores, said other factors being onew which are ignored by most prepayment model calculations of the prior art; (2) determine the differences or errors between the predicted prepayment propensity calculated in step 1 for said selected class of loans and the actual historical prepayment performance of said selected class of loans; (3) derive one or more prepayment scores which, when input to said prepayment model calculation along with said other input arguments tends to reduce the errors between the predicted prepayment propensity and the actual historical prepayment performance. Also disclosed is a method to use the prepayment score in a prepayment model calculation to reduce the prediction errors.

### FIELD OF USE AND BACKGROUND OF THE INVENTION

The mortgage-backed loan market is a five trillion dollars per year business. Substantial revenues are earned by banks from the interest due on mortgage-backed loans. Prepayments of loans, especially mortgage loans, is costly to banks as it represents a major amount of lost interest income. As a result banks, and financial institutions that buys groups of loans from banks or other originators are highly interested in the propensity of the mortgage debtor to prepay the loan before its maturity.

Many factors affect the propensity of mortgage debtors to prepay their mortgage loans. Principal among them is long term mortgage interest rates. When mortgage interest rates drop, homeowners with higher mortgage rates are highly likely to refinance their mortgages. The other reason for prepayments is sale of the property. This aspect is taken into account in prepayment model calculations in a function called the housing turnover component. However many other factors such as the cost of refinancing, the household income, the size of the family, etc. affect the propensity to prepay. The average propensity to prepay based upon changes in long term mortgage rates based upon analysis of historical data is a product which the assignee of present invention Applied Financial Technology has been selling to banks and other customers for several years.

It is not the probability of a particular homeowner refinancing his mortgage that interests banks and buyers of groups of mortgages since no good way to predict the probability of a particular homeowner to prepay a particular loan actually exists since the probability depends on future interest rates, and nobody knows what the future interest rates are going to be.

U.S. Pat. No. 6,185,543 represents one prior art approach to determining loan “prepayment scores” but the way in which U.S. Pat. No. 6,185,543 uses the term “prepayment score” is different than the way this term is used in the context of the invention described herein. U.S. Pat. No. 6,185,543 teaches a method to analyze the specific probability that a particular load will be prepaid by analyzing the demographics associated with a particular borrower and group based prepayment propensity. The history of the borrower, the history of the borrower's demographic group, interest rate trends and other factors are used to calculate a prepayment score that a lender can use to calculate the probability of borrowers to prepay the particular loan in question. This prepayment score can be used by a lender to evaluate the risk of a particular borrower prepaying the loan so that the lender can either offer incentives not to or price the loan differently in terms of points, interest rate, etc. The prepayment scores of a group of individual loans solicited by a loan broker can also be used by the purchaser of the mortgages to evaluate the quality of the portfolio of loans of the broker and thereby evaluate the broker.

The probability that a particular loan taken out by a particular borrower will be prepaid however is not of so much interest to a bank or other institution that may be buying mortgage backed loans. This is because the probability that any particular borrower will refinance will fluctuate as interest rates fluctuate. What is of interest to banks and institutions that buy loans is the functional connection between movements in interest rates and the probability of the loans to refinance. In other words, it is the function which defines the propensity of various loan groups with similar characteristics to be prepaid versus what is happening in the mortgage interest rate area which is of more interest to banks and other financial institutions. Such a function which embodies a prediction of prepayment propensity over time based upon various mortgage interest rate change scenarios is called a prepayment model. Such models are based upon a formula which is derived from studies of historical data showing what actually happened in terms of prepayment for various groups of loans having similar characteristics. Such models give financial institutions tools to calculate the value of a group of similar loans or cost to the bank of the prepayment options in these loans.

The prepayment model is used by inputting each of a plurality of possible future interest rate realizations and their corresponding probabilities as well as other factors which define a class of similar loans such as the weighted average “coupon” or interest rate, the loan type, the age of the loan, etc. As each of these interest rate realizations is run through the prepayment model calculation, a prepayment propensity vector called SMM(360) is calculated (using the function that defines the relationship between the propensity to prepay and interest rate fluctuations). This gives a series of cash flow projections. The sum of these cash flow projections can be used to evaluate the value of a group of loans. Thus, the prepayment model is the functional heart of a system to connect mortgage interest rate movements to interest cash flows lost to prepayments.

What U.S. Pat. No. 6,185,543 attempts to do is present a way to calculate the probability of prepayment of a particular loan or group of loans, but this calculation is impossible since nobody knows what the interest rates are going to do. The way this patent gets around this logical flaw is to use a probability distribution of interest rate fluctuations. However, what banks want is the functional relationship between the interest rate fluctuations and the propensity to prepay.

The propensity to prepay over all these scenarios can be thought of as a surface in a three dimensional space such as is shown in FIG. 1, although such a surface is not an exactly correct representation for reasons which will be explained below. In FIG. 1, the vertical axis (10) labelled SMM represents the prepayment propensity calculated for a specific time (axis 12) and a particular mortgage interest rate (axis 14). A higher point on the SMM axis represents a greater percentage of loans having the characteristics embodied in the coordinates of the point that will prepay. In other words, the higher on the SMM axis a point is, the greater is the percentage of loans having the characteristics embodied in the coordinates of the point that will prepay at that time. Line 16 represents one interest rate scenario and is a prediction of how long term mortgage interest rates will vary over time in one scenario. Lines 18, 20 and 22 represent lines on the SMM three dimensional surface for particular times along axis 12, each point on each of lines 18, 20 and 22 has a specific time coordinate and represents a prediction of prepayment propensity for a particular mortgage interest rate along axis 14 at that particular time. The surface of FIG. 1 is called the prepayment model, and it reflects the relationship between the input factors defined below in the prior art SMM calculation to the SMM vectors, i.e., prepayment propensity predictions over time that result from inputting many different scenarios to the SMM calculation process. SMM vectors output by the prior art prepayment model calculation process are linear vectors with 360 elements. Each element of the SMM vector is a percentage of loans having the characteristics that were input to the prepayment model calculation which will prepay in the month represented by the index in the vector of the element. A different prepayment model surface results for each unique combination of input arguments. A surface does not completely accurately describe the prepayment model however because, the prepayments that are experienced depend upon the path by which each point on the time-mortgage interest rate is reached. For example, when mortgage rates dip below the coupon rates on existing mortgages, many such mortgage holders will refinance. Therefore, suppose a point two years out on the time axis is at the 8% morgage rate and there are a large number of 30 year fixed morgages in existence at 7% coupon rates. Suppose now that mortgage rates dip to 6% for several months and then ramp slowly up to 8% over the next two years. This will cause a large number of refinancing of 7% coupon mortgages during the interval when rates are at 6% with very few refinancings when rates hit 7% or above again. Conversely, suppose mortgage rates rise briefly to 9% , stay there for a few months, and then dip slowly back down to 8% with the same large population of 7% mortgages in existence. This will cause virtually no refinancing during this period of time. At the end of the two year period the population composition will be quite different depending on what path the interest rates will have taken. Therefore, the total number of refinancings that occur when reaching the 8% point two years out depends upon the path that mortgage rates took in getting there.

Another thing about using a surface in a three dimensional space to represent the prepayment model is that it is not just one surface. The prepayment model calculation has a number of different input arguments or variables in any prior art calculation, and the space in which the surface is drawn has only three dimensions. Thus, a prepayment model is more precisely represented by multiple surfaces with each one characterized by one set of input arguments in a multidimensional space having a number of dimensions equal to the number of input variables. Thus, the prepayment model is better represented as a mathematical function of a number of input variables.

When banks have a graph of the SMM surface (or a number of said graphs) or the prepayment model function's outputs for any interest rate scenario and for the classes of mortgages they are interested in evaluating, they have a tool by which they can make educated guesses about the value of their mortgage pool cash flows given various mortgage interest rate fluctuations.

The prepayment model of FIG. 1 has been calculated in the prior art by software libraries which calculate propensity to prepay surfaces for each set of input vector arguments. Such a tool is represented by FIG. 2 at 28. This tool calculates an SMM vector, designated SMM(360), shown at 24, for each input vector, shown at 26. The software 28 embodiments the function that defines the relationship between prepayment propensity and all the input variables including the projected mortgage rate scenarios represented by mortgage interest rate fluctuation input vectors. This function is used to calculate an SMM output vector for each given set of input arguments. The SMM output vector has 360 elements, each of which is a percentage of loans having the characteristics defined by the input arguments which are predicted to refinance given the mortgage interest rate fluctuations in the input arguments. Each input vector has a plurality of arguments. In the prior art, these arguments were: WAC which stands for Weighted Average Coupon, coupon being the interest rate of the loan; WAM which stands for Weighted Average Maturity; Age which is the age of the mortgage from its inception; Loan Type such as fixed 30 years, fixed 15 years; MRATE30(360) which is a vector representing the projected future mortgage interest rates for 30 year fixed loans each month for 360 months; and MRATE15(360) which is a vector representing the projected future mortgage interest rates for 15 year fixed loans each month for 360 months (in other prepayment loan calculation processes, any other market interest rate indicator(s) can be used). Each prepayment model surface calculated by the software library represents one combination of these input factors, and for any given set of factors, the prepayment model function will define the propensity to prepay for loans having those characteristics.

The principal factor which affects the propensity of a mortgage to prepay his mortgage is the movement in mortgage interest rates, and so this prior art model has worked well for many years to predict prepayment propensity over a plurality of mortgage interest rate scenarios.

However, there are several other factors which, are often ignored by the prior art SMM calculation process, but which affect the accuracy of the prepayment propensity prediction calculated by the prior art systems represented by FIG. 2. Some of these factors are more important than others such as family income, loan to value ratio, etc., but each factor that is ignored can affect the accuracy of the prediction of prepayment propensity output by the prepayment modelling process. These other factors include household income of the mortgage borrower, loan-to-value ratio, family size, employment history, salary history, etc. If these factors are ignored by the prior art SMM calculation, they would represent sources of errors or inaccuracy in the prepayment model prediction. Therefore, a need has arisen for a method of doing the SMM calculation that takes one or more of these other factors, into account in calculating the prepayment model surface. Further, there is a need for a method of calculating one or more prepayment score numbers to input to the SMM calculation which summarizes the effects of one or more of these other factors and which tends to cause the prepayment model function output to be altered to an SMM output vector which has fewer predictive errors. These prepayment score numbers are useful communication tools to summarize the effect of the other factors summarized by each prepayment score number. These score can be communicated between market participants without the need to communicate large sets of borrower and loan level information, which is extremely difficult to interpret vis-a-vis its relevance to prepayment propensity. Further, some of the information is confidential and cannot be disclosed to others. Not all prior art prepayment model calculation software ignores these other factors, but no prior art prepayment model calculation software uses one or more prepayment scores which summarize the effects of one or more of these other largely ignored factors to improve the accuracy of prediction and no prior art process to calculate a summary prepayment score exists as far as the applicant is aware.

### SUMMARY OF THE INVENTION

The genus of the process invention to use as input data in addition to the conventional input data one or more prepayment scores that summarize the effects of one or more of the other factors ignored by the prior art, said prepayment scores causing greater accuracy in the prepayment model prediction (hereafter method #1) is characterized by the following steps which all process species within the genus will share.

(1) First, input the conventional SMM arguments with the conventional factors to the SMM prepayment model calculation process.

(2) Second, input one or more prepayment scores, each of which summarizes one or more of the other factors which affect propensity to prepay but which are ignored by the prior art prepayment model calculation, each said score calculated in any way that takes into account the differences or errors between the predicted prepayment propensity and the history of prepayments that actually occurred in a sample group of loans.

(3) Third, do the SMM prepayment model calculations using the conventional factors as well as the one or more additional prepayment scores and output one or more SMM vectors. In the preferred embodiment, SMM(360) is a function of: WAC which stands for Weighted Average Coupon, coupon being the interest rate of the loan; WAM which stands for Weighted Average Maturity; Age which is the age of the mortgage from its inception; Loan Type such as fixed 30 years, fixed 15 years; MRATE30(360) which is a vector representing the projected future mortgage interest rates for 30 year fixed loans each month for 360 months; MRATE15(360) which is a vector representing the projected future mortgage interest rates for 15 year fixed loans each month for 360 months; and score 1 and, optionally, score 2. In other embodiments, some subcombination of these input arguments may be used and other indicators of market interest rates such as 30-year government bond rates, the prime rate, etc. may be substituted. Score1 and optional Score2 and any other optional prepayment scores are new input argument factors each of which summarizes the effect on the accuracy of the prepayment propensity prediction of one or more other factors that are largely ignored by prior art prepayment model calculations. Each prepayment score is a number which when added to the input arguments of the prepayment model, causes the predictive quality of the output SMM(360) vector to improve, Le., causes the errors between the SMM(360) prediction and the actual historical performance to be improved for the class of loans defined by the input arguments.

In various species within this genus, one or more prepayment scores may summarize the effects of the full set of the other factors that affect the accuracy of the prepayment model. In other species, the prepayment score or scores may only summarize the effects of some one or more subsets of these factors down to and including a single other factor ignored by the prior art SMM calculation.

Further, there are a large number of species within this genus of method #1 wherein the differences are the exact manner in which the prepayment score(s) is/are used mathematically to alter the SMM(360) output values to improve the accuracy of the prediction. However, any way in which one or more prepayment scores are input to a prepayment model calculation and which are mathematically combined with the functions in the prior art prepayment model calculation, and/or which are mathematically combined with or operate on the prior art input variables to the prepayment model calculation or which are used as new input variables to modified housing turnover and refinancing functions, and which increase the accuracy of the predictions of the prepayment model are within the scope of this method #1 invention. The prepayment scores referred to in the preceding sentence are numbers or functions which summarize the effects of one or more other factors that affect prepayment propensity and which cause the output of the prepayment model calculation to be more accurate and which are largely ignored in prior art prepayment model calculations.

Examples of some species regarding how the prepayment model is affected by the prepayment scores follow. In some species, a first prepayment score is used to multiply the result from evaluation of the prior art housing turnover function and a second prepayment score is used to multiply times the result from evaluation of the prior art refinance function. In other species, the prepayment score, or some function of the prepayment score, may be used to multiply times one or more of the conventional arguments of the refinance function and/or the housing turnover function with the refinance function and the housing turnover function themselves being unchanged. For example, one species would be:

f=refi((WAC+F2(score2), WAM, score2, age . . . )+housing turnover((WAC+F3(score1), WAM, score1, age . . . ) (1)

where:

f′ is the prepayment model function, as modified to use score1 and score2 to alter the output result, and score1 and score2 are prepayment scores which summarize the effects on the prepayment model predictive qualities of one or more factors which are normally ignored by prepayment model calculations, and

“refi” is either the unchanged refinance function of prior art prepayment models in some species where score2 is not used as a separate input argument, or, in other species within the invention, the prior art refi function is modified in any way to use the score2 input argument to improve the accuracy of the prediction of prepayment propensity, and

“housing turnover” is either the unchanged housing turnover function of prior art prepayment models in some species where score1 is not used as a separate input argument, or, in other species within the invention, the prior art housing turnover function is modified in any way to use score1 as a separate input argument to improve the accuracy of the prediction of prepayment propensity and

f2 and f3 are functions of score2 and score1, respectively, which are determined experimentally, usually by an iterative process, to be such as to reduce the errors between the predicted prepayment propensity of the prior art prepayment model without taking into account the effect of score1 and score2 and the actual historical prepayment performance of the group of loans whose characteristics were the input factors to the prior art prepayment model calculation.

Another species of process to use prepayment scores mathematically to alter the result of the prepayment model calculation would make the following calculation in the prepayment model:

f=F4(score2)*refi((WAC+F2(score2), WAM, score2, age . . . )+F5(score1)*housing turnover((WAC+F3(score1), WAM, score1, age . . . ) (2)

where all terms are as defined above for formula (1) and F4 and F5 are calculated functions of score2 and score1, respectively, which are calculated in any way to improve the accuracy of the prediction of prepayment propensity of the prepayment model calculation of Equation (2).

The genus of the process invention that calculates one or more prepayment scores as a summary of the effect on the prepayment model of one or more of the other factors normally ignored by the prior art SMM calculation (hereafter sometimes referred to as the method #2 invention) is characterized by the following steps that all processes within the genus will share:

(1) Using a computer, analyze a population of loans that have already been made and select those loans having similar characteristic or characteristics in the factual situation such as the same or approximately the same coupon rate, loan type, age and maturity (the input arguments to the prepayment model calculation) and perform a prepayment model calculation on the selected set of loans as a class from which will be derived one or more prepayment scores, each of said prepayment scores summarizing or embodying the effect on the accuracy of the prepayment model prediction of prepayment propensity of one or more other factors not included in the conventional input arguments to the prepayment model calculation;

(2) Determine the differences between the prepayment model projected prepayments for the group of loans selected in step (1) using the prior art SMM calculation process using as input arguments the factors which characterize the class of loans selected in step (1) and which ignore the factors to be summarized in the prepayment score or scores, said difference being derived by comparison to the actual historical prepayment experience on the selected class of loans; and

(3) Derive one or more prepayment score number(s) or functions in any way using any mathematical tools or processes which results in a prepayment score number or numbers which, when input to the conventional SMM prepayment model calculation tends to reduce prediction errors such that the prepayment model (the function relating the input factors to the prepayment propensity) a more accurate predictor, i.e., closer to what actually happened historically in the selected group of loans.

There are at least three major subcategories of species within this genus. In the first subcategory, the score number is derived iteratively by trial and error. In all the species within this subcategory, an initial value for one or more score numbers is selected, and then this value is also input to the SMM prepayment model calculation as an additional input factor. The input vector arguments are limited to those that apply to, i.e. characterize, the class of loans selected in step (1) of the method #2 invention. Then, an SMM vector defining the prepayment model surface are calculated representing the predicted prepayment propensity for this group of loans taking into account whatever factors are summarized by the prepayment score as well as the other factors in the input vector using whatever modified prepayment model is in use which mathematically combines the score1 and score2 numbers into the prior art prepayment model calculation. The differences or errors between this predicted prepayment propensity SMM output vector and the actual historical data are then analyzed to determine if the prepayment score added to the input vector made the prediction more accurate or less accurate. Multiple iterations of this process with changes to the prepayment score made after each iteration are then carried out until a prepayment score is found which reduces the errors or differences to as close to zero as possible or at least as close as is necessary for the purposes to which the prepayment score is to be used.

In the second subcategory, the prepayment score is derived directly using any mathematical means such as by generating a variance/covariance matrix and mathematically deriving therefrom a function (usually in terms of a series of terms multiplied or added to each other, each term having a coefficient) which defines a relationship between the differences or errors and the prior art input factors so as to define one or more score numbers which, when input to the SMM calculation, causes the differences or errors to be reduced or eliminated.

A third major subcategory within the method #2 genus involves the use of manual curve fitting to derive a score which reduces the errors between the predicted prepayment propensity and the actual historical experience. In this subcategory, the prepayment model's predictions of a set of loans that have the other factor or factors to be summarized in the prepayment score are drawn as one graph. Then, on the same display, the actual historical performance for the selected group of loans is drawn. An operator using a curve fitting program then adjusts the predicted performance curve to match as closely as possible the actual historical performance, and requests the program to output a prepayment score or prepayment score function which, when input to the prepayment model calculation results in the adjusted predicted performance curve or surface which reduced the errors or differences as much as possible or at least enough for the purposes to which the prepayment score was to be used.

FIG. 8 is a flow diagram of an automated curve fitting process.

### BRIEF DESCRIPTION OF THE DRAWINGS

FIG. 1 is a diagram of the three dimensional prepayment model surface.

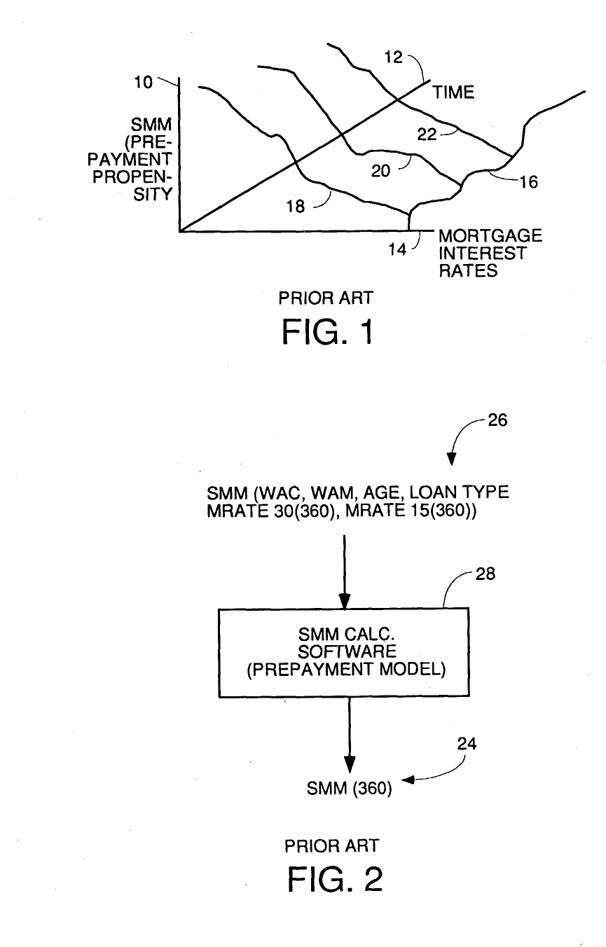

FIG. 2 is a flow chart of the prior art process to calculate the prepayment model SMM vectors ignoring certain factors which affect the accuracy of the prediction.

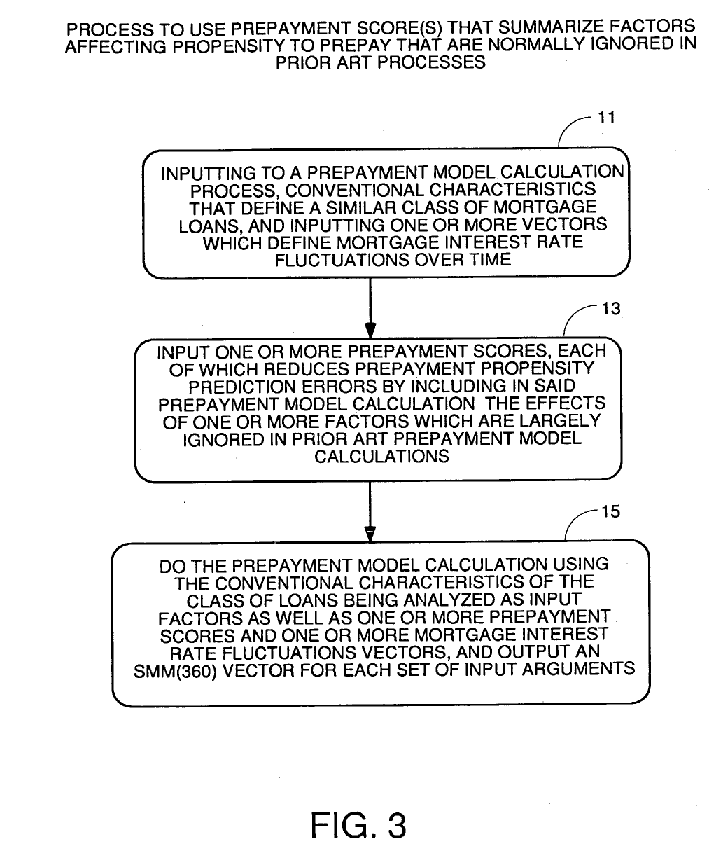

FIG. 3 is a flowchart of the method #1 process to use prepayment scores that summarize factors affecting propensity to prepay that are normally ignored in the prior art prepayment model calculations to improve the accuracy of the prepayment model calculation.

FIG. 4 is a flowchart of the method #2 process to calculate or otherwise derive prepayment scores which summarize the effects of factors which affect prepayment propensity but which are generally ignored in the prior art prepayment model calculations.

FIG. 5 is a flowchart of an iterative method of deriving prepayment scores.

FIG. 6 is a flowchart of a process to use prepayment scores to improve the accuracy of the prepayment model calculation by multiplying the prior art refinancing and housing turnover functions times the prepayment scores.

FIG. 7 is a flowchart of a process to use prepayment scores to improve the accuracy of the prepayment model calculation by multiplying the prior art refinancing and housing turnover functions times the prepayment scores and also adding functions of the prepayment scores to thw WAC input variable to the refinancing and housing turnover prior art functions of the prior art prepayment model calculation.

### DETAILED DESCRIPTION OF THE PREFERRED AND ALTERNATIVE EMBODIMENTS

Two different classes of processes are disclosed herein. The first is a genus of processes to calculate prepayment model SMM vectors taking into account factors which had been ignored in the prior art using one or more “prepayment scores” to summarize the effects of one or more of the factors which affect the accuracy of the prepayment propensity prediction but which had been ignored in the prior art prepayment model calculation. The second genus of processes are processes which are used to generate the prepayment scores used in the first genus of processes.

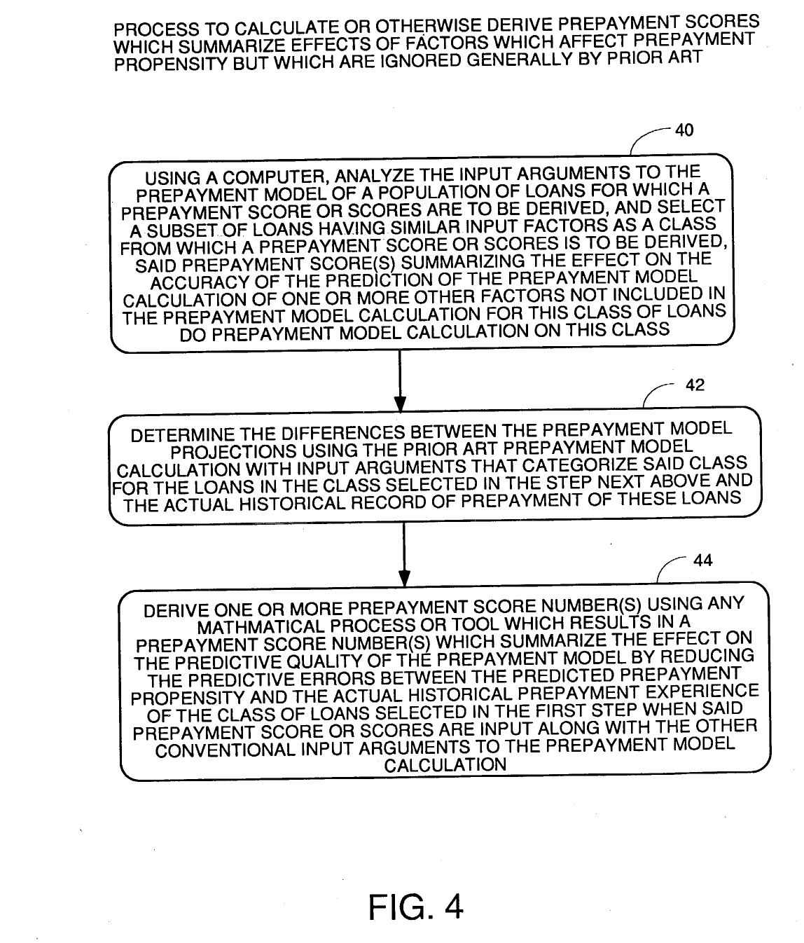

Referring to FIG. 3, there is shown a flowchart of the processing that all species within the genus of processes represented by FIG. 3 will share. Step 11 represents the process of inputting to a prepayment model calculation process, conventional characteristics such as weighted average coupon rate, weighted average maturity, age since inception and loan type that define a class of similar loans and inputting one or more vectors that define mortgage interest rate fluctuation over time scenarios. “Conventional characteristics”, as that term is used in the claims, means WAC and one or more of the following: WAM, factor (as that term is used by those skilled in the art), gross spread (as that term is used by those skilled in the art), age, loan type, regional term (as that term is used by those skilled in the art), mortgage interest rate scenario or treasury bond or any other market interest rate indicators. These conventional arguments are, for the prepayment model calculation used by the assignee of the invention WAC which stands for Weighted Average Coupon, coupon being the interest rate of the loan, and one or more of the following additional input arguments: WAM which stands for Weighted Average Maturity; Age which is the age of the mortgage from its inception; Loan Type such as fixed 30 years, fixed 15 years; MRATE30(360) which is a vector representing the projected future mortgage interest rates for 30 year fixed loans each month for 360 months; and MRATE15(360) which is a vector representing the projected future mortgage interest rates for 15 year fixed loans each month for 360 months (hereafter, references to MRATE30(360) and MRATE15(360) should be understood as references to any other market interest rate indicator as well and only a single market interest rate indicator may be used also). Loans which have approximately the same WAC, WAM, age, and Loan Type are all of the same class and can be mathematically analyzed by the prepayment model calculation given mortgage interest fluctuation scenarios embodied in the MRATE30(360) and MRATE15(360) input vectors.

However, other factors such as family income, loan size, loan to value ratio, number of children in the family, job change history, etc. affect prepayment propensity. In many prepayment models used in the prior art, these other factors are ignored, and, as far as the applicant is aware, no prior art prepayment model uses one or more prepayment scores to summarize the effects on predictive accuracy of one or more of these other factors and inputs that prepayment score to the prepayment model calculation.

Step 13 represents inputting one or more prepayment scores, each of which summarizes the effect on the accuracy of prediction of prepayment propensity of one or more factors that are generally ignored in prior art prepayment calculations. In other words, the prepayment scores which are input to the prepayment model calculation reduce prepayment propensity prediction errors.

Step 15 represents the process of doing the prepayment model calculation using the conventional characteristics as input factors as well as the prepayment score(s) and the mortgage interest rate fluctuation vectors, and outputting an SMM(360) vector for each set of input arguments.

The essence of the first genus of processes is to use the prepayment scores to somehow affect the mathematical calculation of the SMM vector values in any way which improves the accuracy of the prediction. This can be done in a number of different ways, any one of which will suffice as long as the methodology selected improves the accuracy of the prepayment model prepayment propensity prediction. Step 15 represents all these processes. A few examples of ways to use the prepayment scores to affect the prepayment model calculation will illustrate the characteristics of the genus.

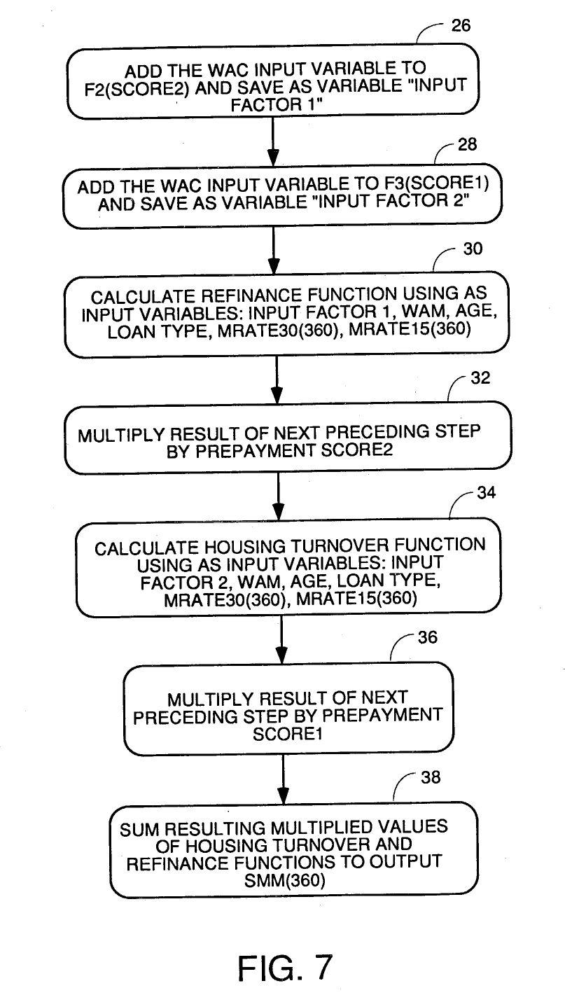

The simplest way to use the prepayment scores to improve the accuracy of the prediction of prepayment propensity is to simply use them as multipliers in the prepayment model formula used in the prior art, as shown in FIG. 6. Typical prior art processes calculate prepayment propensity SMM vectors use a formula which is the sum of a refinance function which uses the input arguments to derive a first vector and a housing turnover function which uses the input arguments to generate another vector. These vectors were summed to generate an SMM(360) vector value at the output. In the simplest species of a method #1 process, a first prepayment score is used to multiply the housing turnover vector, and the second prepayment score is used to multiply the refinance vector. The resulting vectors are summed. In FIG. 6, this process is represented by the following steps: step 16 calculates the prior art refinance function normally using the conventional input factors; step 18 represents multiplication the result of step 16 times a prepayment score 2 to improve the accuracy of the prepayment model prediction; step 20 represents calculation of the prior art housing turnover function normally using the conventional input factors; step 22 represents the process of multiplying the result generated in step 20 times a prepayment score 1 to improve the accuracy of the prediction of prepayment propensity; and step 24 represents summing the resulting vectors generated in steps 18 and 22 to arrive at an output vector SMM(360).

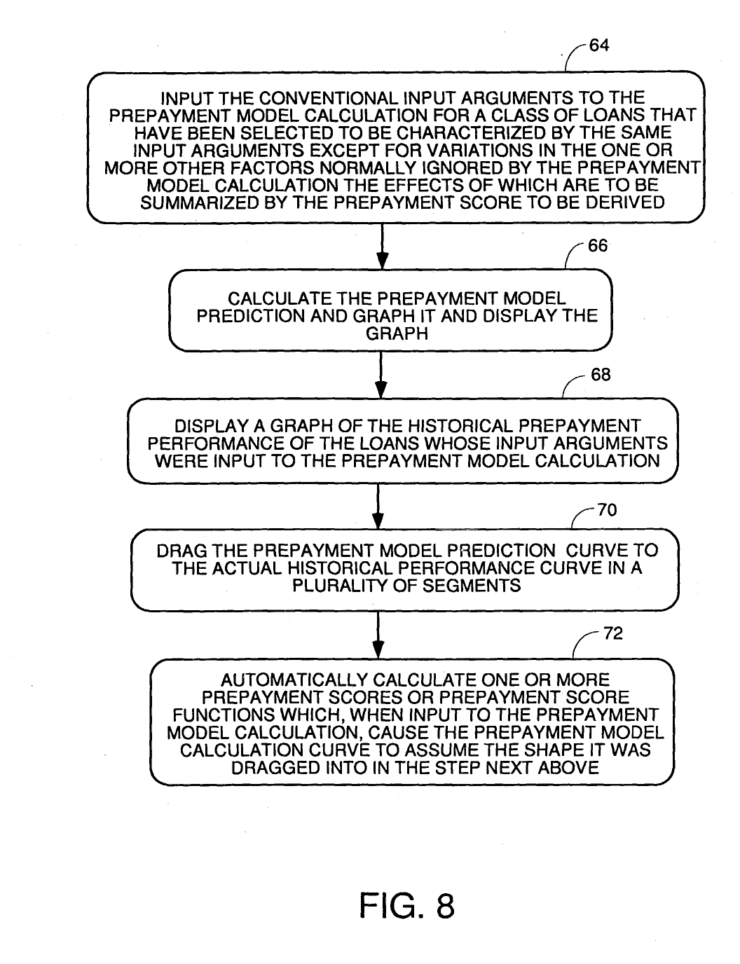

Another way to use prepayment scores to increase accuracy of the prepayment model's predictions is illustrated in FIG. 7. In this species, the prepayment scores are used to both modify the conventional input factors as well as multiply the modified results of the housing turnover and refinance functions. Specifically, step 26 represents the process of adding the conventional WAC input variable (the mortgage loan's interest rate called the coupon rate) to a function F2 of prepayment score 2. The result is stored as “input variable 1”. Step 28 represents the process of adding the WAC input variable to a function F3 of prepayment score 1 and saving the result as “input factor 2”. F2 of prepayment score 2 can be any function that improves the accuracy of the prepayment model prediction. F3 of prepayment score 1 can be any function that improves the accuracy of the prepayment model prediction. Step 30 represents the process of calculating the refinance function conventionally but using as the input variables: input factor 1, WAM, age, loan type, MRATE30(360), and MRATE15(360) (or any other market interest rate indicator). Step 32 represents the process of multiplying the result of step 30 times the prepayment score 2. Step 34 represents the process of calculating the housing turnover function using as input variables: input factor 2; WAM, age, loan type, MRATE30(360), and MRATE15(360). Step 36 represents the process of multiplying the result of step 34 times prepayment score1. Step 38 is the process of summing the vectors generated in steps 36 and 32 to generate an output vector SMM(360).

Another example of a species within the genus of the invention would have the steps of FIG. 7 but would eliminate steps 32 and 36 so that the only effect of the prepayment scores is to alter the values of the input variable WAC. Other examples would be to alter the input variable WAC by multiplication by functions F2 and F3 and use those modified input variables in the refinancing and housing turnover-functions, respectively, or divide WAC by functions F2 and F3 use those modified input variables in the refinancing and housing turnover functions, respectively, or to modify WAC or any other of the input variables by multiplying, dividing, adding or subtracting or raising to a power, etc. by a prepayment score or scores or some function thereof. Any alteration of the input variables of the prior art prepayment model function using one or more prepayment scores or any alteration of the prior art prepayment model refinancing and housing turnover functions to accept one or more prepayment scores as input variables which results in increases in the accuracy of the prediction of prepayment propensity will suffice to practice the invention of method #1.

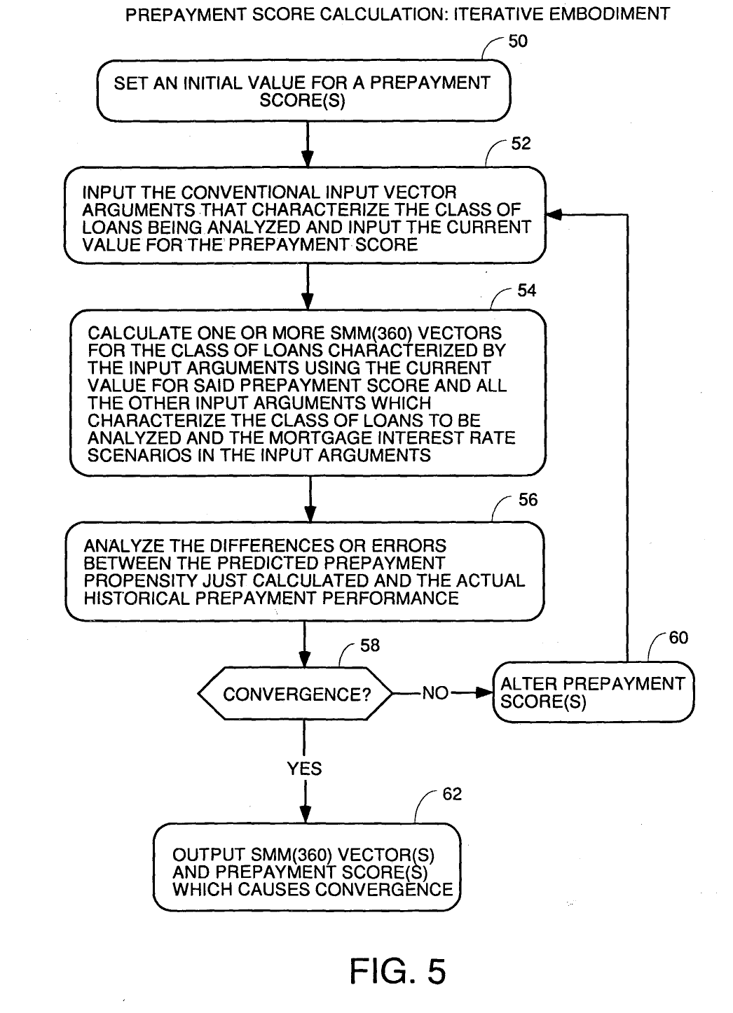

Referring to FIG. 4, there is shown a flowchart represents the processing steps that all species within the genus of the method #2 invention will share. The method #2 genus is a class of processes which calculate or otherwise derive prepayment scores by examining the differences between the predicted prepayment propensity of a class of loans with similar characteristics and the actual historical performance of those loans. Step 40 represents the process of using a computer to analyze the input arguments to a prepayment model of a population of loans for which a prepayment score or scores are to be derived and select or cull out a subset of loans having similar characteristics as defined by their WAC, WAM, age and loan type input parameters. It is from this class of similar loans that prepayment scores which summarize the effects of one or more other factors normally ignored in the prepayment model calculation on the accuracy of the prepayment model's predictions will be derived. After the class of loans is selected, the conventional prepayment model's calculation is performed on the class of loans using as input arguments, those characteristics which define the class and various mortgage interest rate scenarios to generate one or more SMM(360) prepayment propensity predictions.

Step 42 represents the process of determining the differences between the prepayment propensity predictions generated for the selected class of loans as calculated in step 42 and the actual historical performance of the loans of this class as to prepayment. This is a key step, because it is these differences which represent errors between the predicted performance and the actual performance. The object is to generate one or more prepayment scores which minimize these errors.

Step 44 represents the process of deriving one or more prepayment scores using any mathematical process or tool which analyzes the differences between predicted and actual performance and generates one or more prepayment scores which, when input along with the other conventional factors, to the prepayment model calculation, results in a reduction of the errors. There are several ways of doing this, and all are within the scope of the invention, and examples of different species within this genus follow.

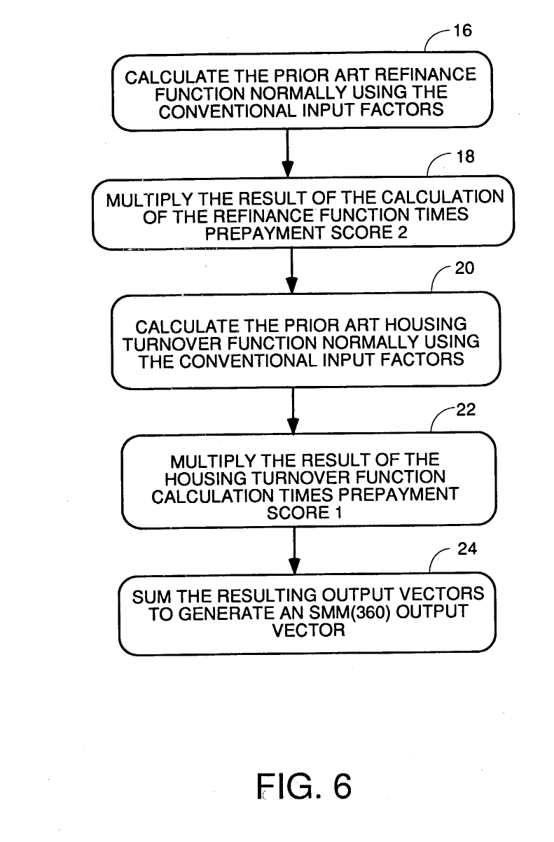

One species within the genus of method #2 is the iterative method of performing step 44 in FIG. 4 shown in flowchart form in FIG. 5. Step 50 represents setting an initial value for a prepayment score. Step 52 represents inputting the conventional input arguments to the prepayment model calculation process for a class of loans which has been selected to be similar as to all input factors except the one or more input factors which affect the accuracy of the prediction but which are typically ignored by prior art prepayment model calculations. The idea here is to isolate the effects on the accuracy of the predictions of the prepayment model by restricting the loan class analyzed to just those loans which have similar input factors except for the factor or factors to be summarized by the prepayment score to be derived iteratively. In other words, by restricting the loan data or input arguments that are analyzed by the prepayment model to just input arguments characterizing a class of similar loans as to the conventional factors, it is possible to derive the statistical significance of variations in the other factors which are normally ignored such as household income, number of people in the family, etc. on the accuracy of the conventional prepayment model calculation compared to the actual historical performance of prepayments of these loans.

Step 54 represents a step of calculating the prepayment model using the conventional input factors which characterize the loan class being analyzed and the initial value for the prepayment score selected in step 50. This will result in altered SMM(360) values which hopefully will be closer to accurately predicting the actual prepayment performance of the class of loans being analyzed for the interest rate scenarios which were input to the calculation process. Step 56 represents the process of analyzing the differences or errors between the SMM(360) output vector predictions of prepayment propensity for the class of loans being analyzed and the actual prepayment performance. This step tells the quality of the current value of the prepayment score in terms of its ability to reduce the errors. Step 58 represents the process of determining if convergence has occurred for the initial value for the prepayment score. This process determines if the predicted prepayment performance of the class of loans as determined by the prepayment model calculation is sufficiently close to the actual historical prepayment performance of the class of loans analyzed, i.e., within a threshold, to declare that the current prepayment score value is adequate to summarize the effects of the factor or factors normally ignored in the prepayment model calculation on the accuracy of the prepayment propensity prediction.

If it is concluded in step 58 that there is insufficient convergence, step 60 is performed to alter the value of the prepayment score. If the direction of alteration needed to push the prepayment propensity calculation toward a lower error prediction is known, the alteration of the prepayment score is in that direction is made, and the process of steps 52, 54, 56 and 58 and 60 is repeated until convergence occurs, and the loop is exited to step 62 where the SMM(360) prepayment propensity prediction vector(s) is/are output along with the prepayment score(s) which caused convergence. If the direction is not known for the alteration in step 60, then any alteration is made, and the process of steps 52, 54, 56 and 58 and 60 is repeated with various values of alteration in step 60 until convergence occurs, and the loop is exited to step 62 where the SMM(360) prepayment propensity prediction vector(s) is/are output along with the prepayment score(s) which caused convergence. Typically, the software will make a first alteration in step 60 when the direction is not known and then analyze in step 56 whether that direction of alteration made the situation better or worse, and if it made it worse, further alterations will be made in the other direction.

Another example of a species within the genus of method #2 is the process for performing step 44 in FIG. 4 using an automated curve fitting process of FIG. 8. In this process, step 64 represents the process of inputting conventional input arguments to the prepayment model calculation for a class of loans that have been selected to be characterized by the same input arguments except for variations in the one or more other factors normally ignored by the prepayment model calculation the effects of which are to be summarized by the prepayment score to be derived. In other words, a class of similar loans has the prepayment model calculated for them. Step 66 represents this prepayment model calculation and graphing on a computer display the prepayment propensity prediction. Step 68 represents the process of graphing on on a computer display the actual historical prepayment performance of the loan class which was input to the prepayment model in step 64. Step 70 can be done automatically by the computer or can be manually done by an operator and represents the process of dragging the prepayment model prediction curve to the actual historical performance curve in a plurality of segments. Step 72 represents the process of the computer automatically calculating one or more prepayment scores or prepayment score functions which, when input to the prepayment model calculation, cause the prepayment model calculation curve to assume the shape it was dragged into in step 70.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A method of calculating a prepayment score, comprising the steps:
(1) analyzing a population of loans and selecting a class of loans which have similar characteristics of coupon rate, loan type, age and weighted average maturity and calculating a prepayment model using said characteristics which define the class as input arguments along with vectors of projected mortgage or other interest rates reflective of mortgage rates with the differences in the loans in said class being variations in one or more other factors which are to be summarized in one or more prepayment scores, said other factors being ones which are ignored by most prepayment model calculations of the prior art;
(2) determine the differences or errors between the predicted prepayment propensity calculated in step 1 for said selected class of loans and the actual historical prepayment performance of said selected class of loans;
(3) derive one or more prepayment scores which, when input to said prepayment model calculation along with said other input arguments tends to reduce the errors between the predicted prepayment propensity and the actual historical prepayment performance.

2. The process of claim 1 wherein steps (2) and (3) are accomplished by deriving one or more prepayment scores by a trial and error process.

3. A process for calculating a prepayment score that summarizes the effects on the accuracy of a prepayment model prediction of prepayment propensity of one or more other factors not included as an input argument to most prepayment model calculations, comprising the steps:
1) setting an initial value for a prepayment score;
2) inputting conventional input vector arguments to a prepayment model calculation process wherein the conventional input vector arguments are limited to arguments which characterize a class of similar loans in terms of the same or similar coupon rate, average maturity, age since inception and loan type and that have already been made, said conventional input vector arguments also including mortgage interest rate fluctuation projections;
3) inputting the current value of said prepayment score to said prepayment model calculation;
4) performing said prepayment model calculation using said conventional input vector arguments and the current value of said prepayment score;
5) analyze the differences or prediction errors between the predicted prepayment propensity resulting from the calculation of step 4 and the actual prepayment history of said class of loans which were input to said prepayment model calculation, and determine if said errors are smaller than any threshold value used to determine when said prepayment score is close enough to reduce prediction errors to an acceptable level;
6) if said prediction errors are not smaller than said threshold, altering said prepayment score by some incremental amount, and repeating steps 2, 3, 4, 5 and 6 until said prediction errors are less than said threshold;
7) when said prediction errors are less than said threshold, outputting an SMM(360) vector which represents prepayment propensity over time for the class of loans input to said prepayment model calculation.

4. The process of claim 3 wherein step 7 further comprises outputting the prepayment score which resulted in convergence.

5. A process for calculating a prepayment score, comprising the steps:
1) selecting a class of loans that have already been made and which have similar conventional characteristics of weighted average coupon rates, weighted average maturity, age since inception and loan type with variances between loans in said class in other factors than those conventional characteristics identified above, and inputting these conventional characteristics along with one or more vectors which define mortgage interest rate fluctuations over time into a prepayment model calculation process;
2) performing said prepayment model calculation and displaying a curve on a computer screen which shows the predicted prepayment propensity over time;
3) displaying on said computer screen a curve which shows the actual historical experience for prepayment of said class of loans input to said prepayment model calculation;
4) manually or automatically reshaping said curve displayed step 2 by dragging segments of said curve which are small enough and sufficient in number to allow the curve displayed in step 2 to be approximately reshaped to the shape of the curve displayed in step 3; and
5) automatically calculating one or more prepayment scores or prepayment score functions, which, when input to said prepayment model calculation along with the same conventional characteristics and the same mortgage interest rate fluctuation vectors, results in said curve of prepayment propensity to be altered to approximately the shape into which it was reformed in step 4, thereby reducing the prediction errors.

6. A process of using prepayment scores to improve the accuracy of prediction of a prepayment model calculation, comprising the steps:
1) inputting to a prepayment model calculation process, conventional characteristics that define a class of similar loans and inputting one or more vectors that define mortgage interest rate fluctuation over time scenarios;
2) inputting to said prepayment model calculation one or more prepayment scores, each of which reduces prepayment propensity prediction errors;
3) do the prepayment model calculation using the conventional characteristics of the class of loans being analyzed as and the morgage rate fluctuation vector(s) and said prepayment score(s) as input factors, and output a more accurate prepayment propensity prediction.

7. The process of claim 6 wherein step 3 comprises the steps:
4) calculating the prior art refinance function of a prior art prepayment model calculation normally using the conventional characteristics of the loan class being analyzed as input factors;
5) multiplying the result of step 4 times a first prepayment score or first prepayment score function, said first prepayment score or first prepayment score function being such as to reduce the predictive error between prepayment propensity predicted by said prepayment model calculation and actual prepayment experience of the loan class being analyzed;
6) calculating the prior art housing turnover function of a prior art prepayment model calculation using the conventional characteristics of the loan class being analyzed as input factors;
7) multiplying the result of step 6 by a second prepayment score or second prepayment score function, said second prepayment score or second prepayment score function being such as to reduce the predictive error between prepayment propensity predicted by said prepayment model calculation and actual prepayment experience of the loan class being analyzed;
8) summing the results of steps 5 and 7 and outputting the result as an SMM(360) prepayment model prepayment propensity prediction.

8. The process of claim 6 wherein step 3 comprises the steps:
4) adding the conventional weighted average coupon variable of a prior art prepayment model calculation to a first function of a first prepayment score and saving the result as input factor 1;
5) adding the conventional weighted average coupon variable of a prior art prepayment model calculation to a second function of a second prepayment score and saving the result as input factor 2;
6) calculating the prior art refinance function of a prior art prepayment model calculation normally using the conventional characteristics of the loan class being analyzed as input factors but substituting input factor 1 for the weighted average coupon varialbe;
7) multiplying the result of step 6 times a first prepayment score or first prepayment score function, said first prepayment score or first prepayment score function being such as to reduce the predictive error between prepayment propensity predicted by said prepayment model calculation and actual prepayment experience of the loan class being analyzed;
8) calculating the prior art housing turnover function of a prior art prepayment model calculation using the conventional characteristics of the loan class being analyzed as input factors but substituting said input factor 2 for the conventional weighted average coupon variable;
9) multiplying the result of step 8 by a second prepayment score or second prepayment score function, said second prepayment score or second prepayment score function being such as to reduce the predictive error between prepayment propensity predicted by said prepayment model calculation and actual prepayment experience of the loan class being analyzed;
8) summing the results of steps 7 and 9 and outputting the result as an SMM(360) prepayment model prepayment propensity prediction.

9. The process of claim 6 wherein step 3 comprises the steps:
4) adding the conventional weighted average coupon variable of a prior art prepayment model calculation to a first function of a first prepayment score and saving the result as input factor 1;
5) adding the conventional weighted average coupon variable of a prior art prepayment model calculation to a second function of a second prepayment score and saving the result as input factor 2;
6) calculating the prior art refinance function of a prior art prepayment model calculation normally using the conventional characteristics of the loan class being analyzed as input factors but substituting input factor 1 for the weighted average coupon varialbe;
7) calculating the prior art housing turnover function of a prior art prepayment model calculation using the conventional characteristics of the loan class being analyzed as input factors but substituting said input factor 2 for the conventional weighted average coupon variable;
8) summing the results of steps 6 and 7 and outputting the result as an SMM(360) prepayment model prepayment propensity prediction.

10. The process of claim 6 wherein step 3 comprises the steps:
4) mathematically combining a first prepayment score or a function of a first prepayment score with any of the conventional arguments which are input to a prior art refinancing function calculation of a prior art prepayment model calculation, said first prepayment score or function of said first prepayment score being indicative of propensity to prepay based upon one or more factors that affect prepayment propensity but which are ignored by most prepayment model calculations, and said mathematical combination being any mathematical combination with any one or more of said conventional arguments in such a way as to reduce the predictive errors between the predicted propensity to prepay output by said prepayment model and the actual historical performance of the class of similar loans input to said prepayment model calculation, and saving the result as input factor 1;
5) mathematically combining a second prepayment score or a function of a second prepayment score with any of the conventional arguments which are input to a prior art housing turnover function calculation of a prior art prepayment model calculation, said second prepayment score or function of said second prepayment score being indicative of propensity to prepay based upon one or more factors that affect prepayment propensity but which are ignored by most prepayment model calculations, and said mathematical combination being any mathematical combination with any one or more of said conventional arguments in such a way as to reduce the predictive errors between the predicted propensity to prepay output by said prepayment model and the actual historical performance of the class of similar loans input to said prepayment model calculation, and saving the result as input factor 2;
6) calculating the prior art refinancing function of a prior art prepayment model calculation normally using the conventional characteristics of the loan class being analyzed as modified by said mathematical combination with said first prepayment score or a function of said first prepayment score as input factors;
7) calculating the prior art housing turnover function of a prior art prepayment model calculation using the conventional characteristics of the loan class being analyzed, as modified by mathematical combination with said second prepayment score or a function of said second prepayment score as input factors;
8) summing the results of steps 6 and 7 and outputting the result as an SMM(360) prepayment model prepayment propensity prediction.

11. A computer-readable medium having computer-executable instructions for performing a method, comprising:
(1) analyzing a population of loans and selecting a class of loans which have similar characteristics of coupon rate, loan type, age and weighted average maturity and calculating a prepayment model using said characteristics which define the class as input arguments along with vectors of projected mortgage or other interest rates reflective of mortgage interest rates, with the differences in the loans in said class being variations in one or more other factors which are to be summarized in one or more prepayment scores, said other factors being onew which are ignored by most prepayment model calculations of the prior art;
(2) determine the differences or errors between the predicted prepayment propensity calculated in step 1 for said selected class of loans and the actual historical prepayment performance of said selected class of loans;
(3) derive one or more prepayment scores which, when input to said prepayment model calculation along with said other input arguments tends to reduce the errors between the predicted prepayment propensity and the actual historical prepayment performance.

12. A computer-readable medium having computer-executable instructions for performing a method, comprising:
1) setting an initial value for a prepayment score;
2) inputting conventional input vector arguments to a prepayment model calculation process wherein the conventional input vector arguments are limited to arguments which characterize a class of similar loans in terms of the same or similar coupon rate, average maturity, age since inception and loan type and that have already been made, said conventional input vector arguments also including mortgage interest rate fluctuation projections;
3) inputting the current value of said prepayment score to said prepayment model calculation;
4) performing said prepayment model calculation using said conventional input vector arguments and the current value of said prepayment score;
5) analyze the differences or prediction errors between the predicted prepayment propensity resulting from the calculation of step 4 and the actual prepayment history of said class of loans which were input to said prepayment model calculation, and determine if said errors are smaller than any threshold value used to determine when said prepayment score is close enough to reduce prediction errors to an acceptable level;
6) if said prediction errors are not smaller than said threshold, altering said prepayment score by some incremental amount, and repeating steps 2, 3, 4, 5 and 6 until said prediction errors are less than said threshold;
7) when said prediction errors are less than said threshold, outputting an SMM(360) vector which represents prepayment propensity over time for the class of loans input to said prepayment model calculation.

13. A computer-readable medium having computer-executable instructions for performing a method, comprising:
1) inputting to a prepayment model calculation process, conventional characteristics of weighted average coupon rate, weighted average maturity, age since inception and loan type that define a class of similar loans and inputting one or more vectors that define mortgage interest rate fluctuation over time scenarios;
2) inputting to said prepayment model calculation one or more prepayment scores, each of which reduces prepayment propensity prediction errors;
3) doing the prepayment model calculation using the conventional characteristics of the class of loans being analyzed as and the morgage rate fluctuation vector(s) and said prepayment score(s) as input factors, and output a more accurate prepayment propensity prediction.
